(19) United States
(12) Patent Application Publication
(10) Pub. No.: US 2024/0308474 A1
(43) Pub. Date: Sep. 19, 2024

(54) Dual-Blade Wiper Blade

(71) Applicant: Illinois Tool Works Inc., Glenview, IL (US)

(72) Inventor: Guozhen Yang, Houston, TX (US)

(21) Appl. No.: 18/590,301

(22) Filed: Feb. 28, 2024

Related U.S. Application Data
(60) Provisional application No. 63/451,845, filed on Mar. 13, 2023.

(51) Int. Cl. B60S 1/38; B60S 1/28

(52) U.S. Cl. CPC B60S 1/3848; B60S 1/28; B60S 2001/3831; B60S 2001/3834; B60S 2001/3837

(57) ABSTRACT

Described is a dual-blade wiper blade for a windshield of a vehicle. The dual-blade wiper blade has a frame structure, a squeegee, a wiping lip, and a scraping lip. The squeegee coupled to the frame structure. Each of the wiping lip and the scraping lip are coupled to the squeegee. The scraping lip being positioned in parallel with the wiping lip.

### RELATED APPLICATION

The present application claims priority to U.S. Provisional Patent Application No. 63/451,845, filed Mar. 13, 2023, and entitled “Dual-Blade Wiper Blade” which is hereby incorporated by reference in its entirety.

### BACKGROUND

Windshield wipers are used to remove rain, snow, ice, washer fluid, water, and/or other debris from a vehicle's front or rear windshield. Almost all vehicles are equipped with one or more windshield wipers, including cars, trucks, buses, train locomotives, watercraft (e.g., those with a cabin) and even some aircraft. In many jurisdictions, windshield wipers are a legal requirement.

Vehicles use a variety of wiper blade types and configurations, but a common objective for all wiper blade types is that they conform to the surface and/or contour of the glass upon which they are mounted (whether a front or rear windshield) to effectively clear the windshield. Wiper blades are typically optimized to perform against liquid, but not to effectively remove common debris from the windshield, such as dirt, insects, bird waste, and other forms of organic debris. Prior attempts to address the debris removal used embossed features on the wiper blade rubber element surface. However, such embossed features do not allow the rubber element to make proper contact with the windshield and often result in poor wipe quality performance.

To overcome the poor performance, dual-blade designs use two rubber elements in tandem to remove the organic debris and streaks from the windshield. Dual-blade wiper blades are available on the market to improve the cleaning performance; however, existing dual-blade wiper blades employ a pair of matching rubber elements. For example, existing dual-blade wiper blades don't account for the curvature of windshield and the angle between blades and windshield. Thus, the efficacy of second rubber element is limited and can even interfere with the first rubber element.

Despite advancements to date, a need exists for an improved dual-blade wiper blade that can effectively clear debris without introducing streaks to the windshield.

### SUMMARY

The present disclosure relates generally to an improved dual-blade wiper blade, substantially as illustrated by and described in connection with at least one of the figures, as set forth more completely in the claims. More specifically, the present disclosure relates to an improved dual-blade wiper blade that can effectively clear debris without introducing streaks to the windshield.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an example vehicle having a windshield and a pair of dual-blade wiper blades.

FIG. 1b illustrates an assembly view of an example connection point between the dual-blade wiper blade and the wiper arm.

FIG. 2 illustrates a perspective side view of a dual-blade wiper blade in accordance with an aspect of the present disclosure.

FIGS. 3a through 3c illustrate the dual-blade wiper blade during three stages of operation.

FIG. 3d illustrates an assembly view of the dual-blade wiper blade in accordance with another aspect of the present disclosure.

FIGS. 4a through 4d illustrate state diagrams of the dual-blade wiper blade during various stages of operation.

FIGS. 5a and 5b illustrate perspective underside views of a dual-blade wiper blade in accordance with other aspects of the present disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Wiper blades used in vehicles vary in size and shape. In some cases, wiper blades can be the same shape, but will vary in size. While wiper blades are most often associated with automobiles (e.g., cars, trucks, etc.), they are likewise employed in numerous other vehicles, such as trains, watercraft, and aircraft. Therefore, the following disclosure should not be limited to wiper blades and wiper arms used in automobiles, but rather would be applicable to wiper blades and wiper arms used in any type of vehicle.

The present disclosure relates to an improved dual-blade wiper blade that can effectively clear debris without introducing streaks to the windshield. As will be described, the dual-blade wiper blade is mechanically designed such that the secondary blade (e.g., a second rubber element) strengthens the cleaning performance of the dual-blade wiper blade without sacrificing the efficacy of primary blade (e.g., a first rubber element).

In one example, a dual-blade wiper blade for a windshield (102) of a vehicle (100) comprises a frame structure, a squeegee coupled to the frame structure, a wiping lip coupled to the squeegee, and a scraping lip coupled to the squeegee and positioned in parallel with the wiping lip.

The wiping lip extends from the squeegee at a first height (H₁) and the scraping lip extends from the squeegee at a second height (H₂) that is different form the first height (H₁). In some examples, the second height (H₂) is less than the first height (H₁). For example, the first height (H₁) can be between 50% and 100% greater than the second height (H₂). In another example, the first height (H₁) can be between 60% and 90% greater than the second height (H₂).

In one example, the wiping lip is a first rubber element and the scraping lip is a second rubber element. The first rubber element can be less rigid than the second rubber element. In another example, the wiping lip is a rubber element and the scraping lip is a brush. In yet another example, the wiping lip is a rubber element and the scraping lip is a sponge. In yet another example, the wiping lip is a rubber element and the scraping lip is a scrubbing pad. In some examples, the wiping lip comprises a hard coating. In some examples, the scraping lip is removably coupled to the squeegee.

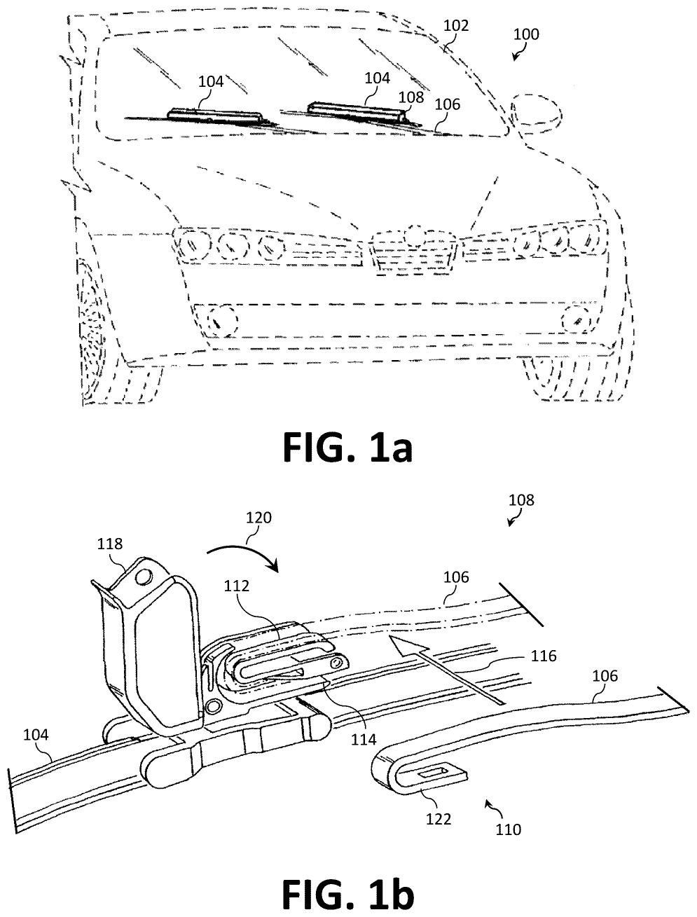

FIG. 1a illustrates an example vehicle 100 having a windshield 102 and a pair of dual-blade wiper blades 104. As illustrated, each dual-blade wiper blade 104 is removably coupled to a wiper arm 106 of the vehicle 100 via a coupling 108. As is known in the art, the wiper arms 106 (and, therefore, the dual-blade wiper blades 104) are configured to translate back and forth across the windshield 102 to clear the windshield 102 of rain, snow, and debris via one or more electric motors and mechanical linkages associated with the vehicle 100.

FIG. 1b illustrates an assembly view of an example coupling 108 between the dual-blade wiper blade 104 and the wiper arm 106. As illustrated, each wiper arm 106 includes or otherwise defines, at its distal end, an arm-side connector 110. The arm-side connector 110 is configured to engage and secure the dual-blade wiper blade 104 via a complimentary blade-side connector 112 positioned on or otherwise associated with the dual-blade wiper blade 104. In the illustrated example, the arm-side connector 110 is inserted into a J-shaped slot 114 of the blade-side connector 112 as indicated by arrow 116. Once assembled, a locking cap 118 can be folded as indicated by arrow 120 (e.g., pivoted about a hinge) and positioned to cover, secure, and protect the connected arm-side connector 110 and blade-side connector 112. In the illustrated example, the wiper arm 106 includes an arm-side connector 110 configured a J-Hook connector 122, but other connector types are contemplated.

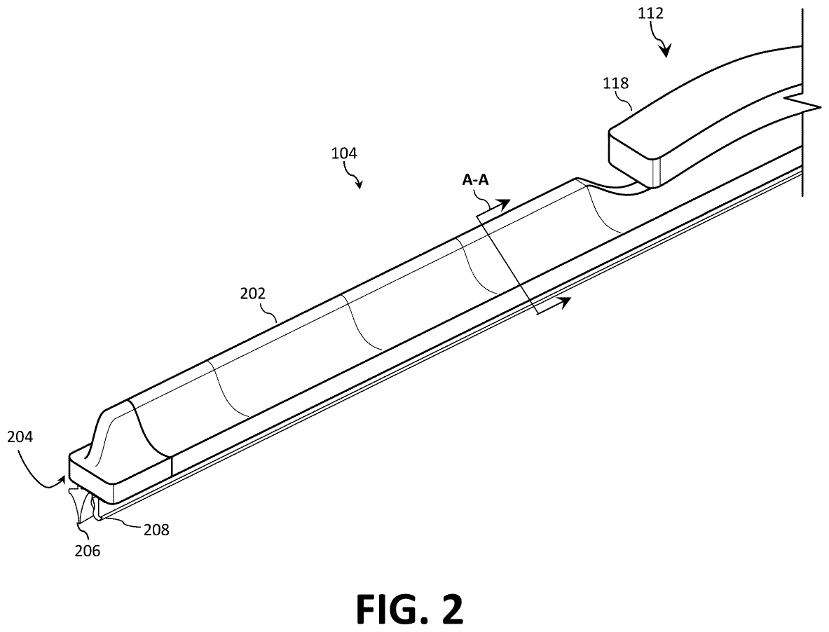

FIG. 2 illustrates a perspective side view of a dual-blade wiper blade 104 in accordance with an aspect of the present disclosure. The dual-blade wiper blade 104 generally comprises a frame structure 202, a squeegee 204, a wiping lip 206, and a scraping lip 208. The frame structure 202 is configured to couple to the wiper arm 106 via the blade-side connector 112 of the coupling 108. The blade-side connector 112 may be integral with the frame structure 202 or attached thereto via one or more fasteners, adhesives, etc. The length of the frame structure 202, the squeegee 204, the wiping lip 206, and the scraping lip 208 will depend on the vehicle 100 as the length of a dual-blade wiper blade 104 will vary depending on the type of vehicle 100.

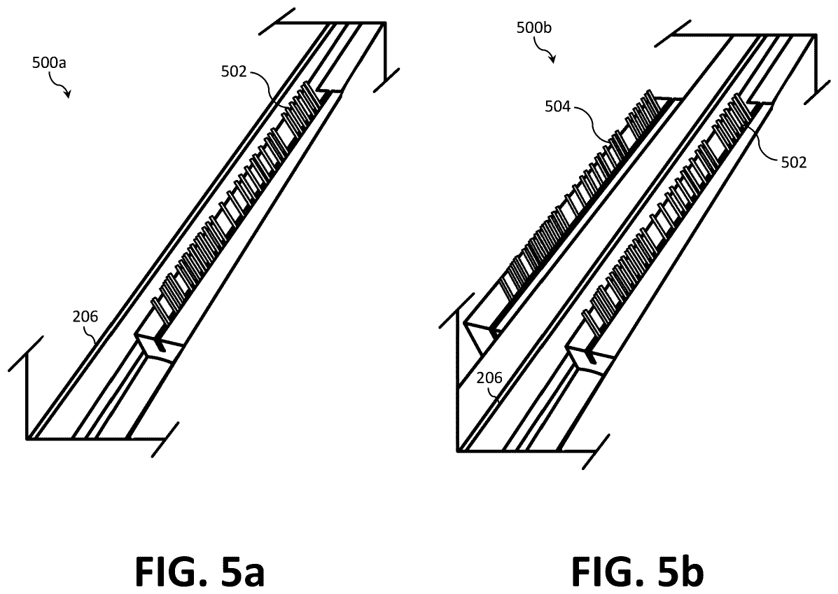

One or more of the squeegee 204, the wiping lip 206, and/or the scraping lip 208 may be separate components and/or formed of a different material. For example, the material of the scraping lip 208 can be harder (e.g. more rigid) and/or more abrasive than the material used for the wiping lip 206. In fact, structures other than a rubber element can be used, such as a brush, a sponge, a scrubbing pad, etc. Example brushes are described in connection with FIGS. 5a and 5b.

In some examples, a coating may be applied over the wiping lip 206 and/or the scraping lip 208 to mitigate the effects of the environment, such as debris. An example coating may include a non-stick or hydrophobic coating that mitigates the effects of debris and liquid by easily brushing the debris and liquid away from the wiping lip 206 and/or the scraping lip 208. In another example, the scraping lip 208 can be coated with a hard coating to increase durability. Such a hard coating may contain hard, micro-structure, solid chemical to increase the roughness on the leading edge 308 of the scraping lip 208, such as fiber (e.g., fiber glass) and particles (e.g., graphite, clay, aluminum oxide, etc.).

The dual-blade wiper blade 104 and components thereof (e.g., the frame structure 202, the squeegee 204, the wiping lip 206, and/or the scraping lip 208) can be fabricated from one or more elastomeric materials. Example elastomeric materials include, for example, thermoplastic polyurethane (TPU), thermoplastic vulcanizates (TPV), thermoplastic elastomers (TPE), flexible polyurethane (FPU), silicon, etc. In some examples, two or more components of the dual-blade wiper blade 104 can be formed from the same material and/or as a single, integrated component. For example, the squeegee 204 and the wiping lip 206 could be fabricated as a single component, while the scraping lip 208 could be a separate component formed from a material that is different from that of the squeegee 204 and the wiping lip 206.

In some examples, the dual-blade wiper blade 104 (or a portion thereof) can be a printed plastic material component (e.g., thermoplastic, TPU, FPU, etc.). Printed plastic material components can be printed with great accuracy and with numerous details, which is particularly advantageous, for example, in creating components requiring complex and/or precise features. In addition, additive manufacturing techniques obviate the need for mold tooling, thereby lowering up-front manufacturing costs, which is particularly advantageous in low-volume productions. In some examples, the dual-blade wiper blade 104 may be fabricated using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

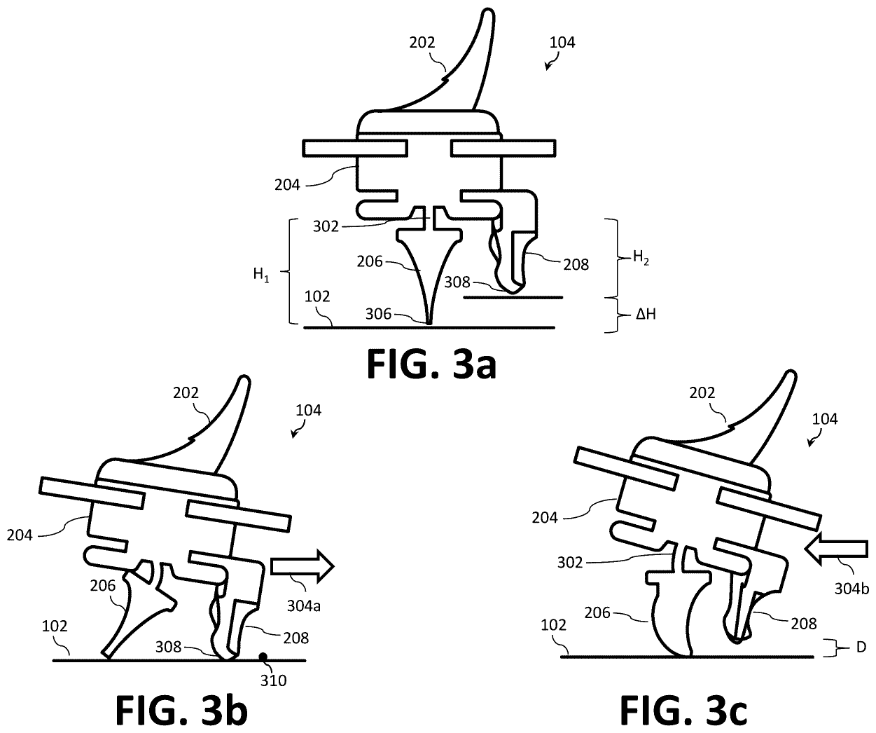

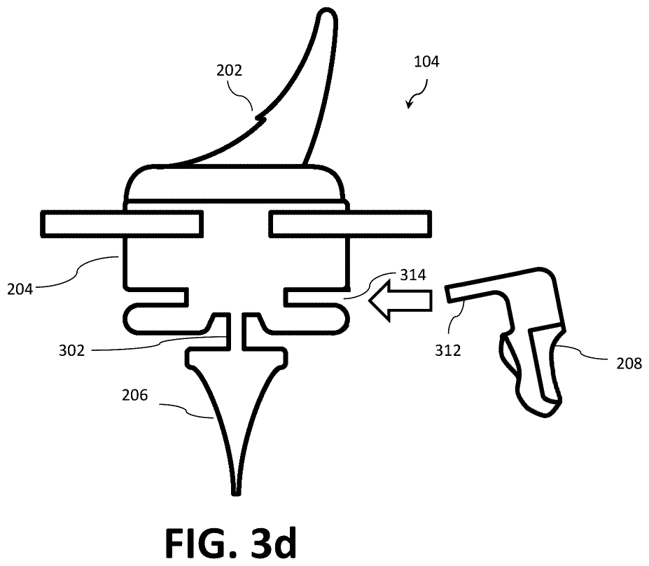

FIGS. 3a through 3c illustrate cross-sectional views of the dual-blade wiper blade 104 along cut line A-A during three stages of operation, while FIG. 3d illustrates an assembly view of the dual-blade wiper blade 104 in accordance with another aspect of the present disclosure. Specifically, FIG. 3a illustrates the dual-blade wiper blade 104 in a static state, while FIGS. 3b and 3c illustrate the dual-blade wiper blade 104 translating across a windshield 102 in, respectively, a first direction 304a and a second direction 304b that is opposite that of the first direction 304a. As is known in the art, each cycle includes a translation of the dual-blade wiper blade 104 across the windshield 102 in the second direction 304b and then back in the first direction 304a. FIG. 3d illustrates the dual-blade wiper blade 104 having the scraping lip 208 configured as a detachable component.

The wiping lip 206 extends from the squeegee 204 at a first height (H₁) and the scraping lip 208 extends from the squeegee 204 at a second height (H₂) that is different form the first height (H₁). With reference to FIG. 3a, the height (H₁) of the wiping lip 206 is different from the height (H₂) of the scraping lip 208 by a height different (ΔH). As illustrated, the second height (H₂) is less than the first height (H₁). As used herein, the height (H₁) of the wiping lip 206 and the height (H₂) of the scraping lip 208 refer to the distance that the respective one of the wiping lip 206 and the scraping lip 208 projects from the underside of the squeegee 204. As illustrated, when a leading edge 306 of the wiping lip 206 first contacts a surface of the windshield 102 (prior to being deformed/pressed against the windshield 102), a leading edge 308 of the scraping lip 208 is spaced from the surface of the windshield 102 by a distance (D) that is equal to the height different (ΔH).

As will be described, the height different (ΔH) allows the scraping lip 208 to better perform without adversely affecting the performance of the wiping lip 206. In some examples, the first height (H₁) is between 50% and 100% greater than the second height (H₂), or about between 60% and 90% greater than the second height (H₂); however, as will be discussed, the spacing (width) between the wiping lip 206 and the scraping lip 208 is also a consideration.

As best illustrated in FIGS. 3b and 3c, during operation of the dual-blade wiper blade 104, the squeegee 204 torques and tilts relative to the windshield 102 as the dual-blade wiper blade 104 moves between the first direction 304a and the second direction 304b. As the wiping lip 206 flexes back and forth about a flexible pivot point 302, the distance (D) between the leading edge 308 of the scraping lip 208 and the windshield 102 changes.

As illustrated, when moving in the first direction 304a as illustrated in FIG. 3b, the wiping lip 206 is flexed in a direction away from the scraping lip 208 such that the distance (D) is zero and the leading edge 308 of the scraping lip 208 contacts the windshield 102. As the leading edge 308 of the scraping lip 208 moves across the windshield 102, it scrapes organic debris 310 from the windshield 102. To that end, the scraping lip 208 may be more rigid than the wiping lip 206 to better scrape debris 310. Conversely, when moving in the second direction 304b as illustrated in FIG. 3c, the wiping lip 206 is flexed in a direction toward the scraping lip 208 and the scraping lip 208 is lifted from the windshield 102 by a distance (D) that is less than the height different (ΔH), but greater than zero. As a result, the wiping lip 206 is able to wipe away water and the scraping lip 208 lifted from the windshield to avoid introducing streaks to the windshield.

While the squeegee 204, the wiping lip 206, and the scraping lip 208 can be a unitary structure formed, the scraping lip 208 could be provided as a separate component that can be later-added and/or replaceable (e.g., clipped onto an existing wiper blade) to, in effect, convert a single-blade wiper blade into a dual-blade wiper blade. For example, as best illustrated in FIG. 3d, the scraping lip 208 may include a protruding feature 312 that is sized and shaped to snap or otherwise reside within a recess 314 (e.g., a slot or other feature) formed in the squeegee 204.

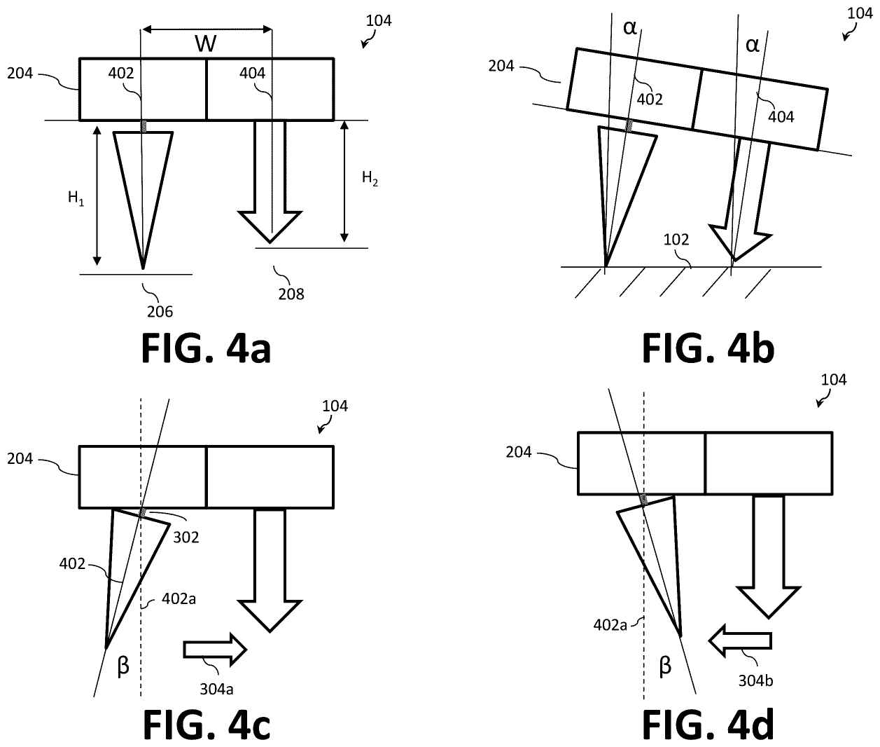

FIGS. 4a through 4d illustrate state diagrams for the dual-blade wiper blade 104 during various stages of operation. Specifically, FIG. 4a illustrates a state diagram of the dual-blade wiper blade 104 in a static state (e.g., as illustrated in FIG. 3a), while FIG. 4b illustrates a state diagram of the dual-blade wiper blade 104 in a static state, but positioned relative to a windshield 102. FIGS. 4c and 4d illustrate state diagrams for the dual-blade wiper blade 104 translating across the windshield 102 in, respectively, the first direction 304a and the second direction 304b (e.g., as illustrated in Figured 3b and 3c).

The height (H₂) the scraping lip 208 is shorter than the height (H₁) of the wiping lip 206, which can be calculated as a function of the height (H₁) of the wiping lip 206, the distance (i.e., width (W)) between wiping lip 206 and scraping lip 208, and the various angles (e.g., angles α and β) between the dual-blade wiper blade 104 and windshield 102. Therefore, the height (H₂) and location of the scraping lip 208 are configured such that the leading edge 308 touches the windshield 102 during upward wiping (e.g., the first direction 304a) and does not touch the windshield 102 during the downward wiping (e.g., the second direction 304b). Thus, during the upward wiping, the scraping lip 208 can remove debris from the windshield 102, while the wiping lip 206 wipes residue that has been wiped and/or left by scraping lip 208. During the downward wiping, the wiping lip 206 can wipe the windshield without interference from the scraping lip 208.

As best illustrated in FIG. 4a, the wiping lip 206 defines a primary central axis 402 and the scraping lip 208 defines a secondary central axis 404. As illustrated, the primary central axis 402 and the secondary central axis 404 are substantially parallel to one another and spaced away from one another by a width (W). When installed, as illustrated in FIG. 4b, the primary central axis 402 and the secondary central axis 404 each define a first angle (a) relative to the surface of the windshield 102.

When the dual-blade wiper blade 104 translates across the windshield 102 in the first direction 304a as illustrated in FIG. 4c, the wiping lip 206 flexes back (against the first direction 304a) about a flexible pivot point 302. As a result, the primary central axis 402 shifts relative to the original axis 402a (i.e., the axis of the wiping lip 206 when in a static state) by a second angle (β).

Similarly, when the dual-blade wiper blade 104 translates across the windshield 102 in the second direction 304b as illustrated in FIG. 4d, the wiping lip 206 flexes forward (against the second direction 304b) about the flexible pivot point 302. As a result, the primary central axis 402 shifts relative to the original axis 402a (i.e., the axis of the wiping lip 206 when in a static state) by the second angle (β), but in the opposite direction (e.g., a positive β v. a negative β).

When the dual-blade wiper blade 104 translates in the first direction 304a, the height (H₁) of the wiping lip 206 and the height (H₂) of the scraping lip 208 are dictated by the following equation (Equation 1):

$${H}_{1} * cos ( α + β ) - W * sin ( α ) < {H}_{2} * cos ( α ) \qquad Equation 1$$

In this case, an objective is to target a height different (ΔH) such that the wiping lip 208 contacts the windshield 102. When the dual-blade wiper blade 104 translates in the second direction 304b, the height (H₁) of the wiping lip 206 and the height (H₂) of the scraping lip 208 are dictated by the following equation (Equation 2):

$${H}_{1} * cos ( α - β ) - W * sin ( α ) > {H}_{2} * cos ( α ) \qquad Equation 2$$

The height (H₁) of the wiping lip 206 and the height (H₂) of the scraping lip 208, or ratio between the two, can be determine using the following equation (Equation 3), where a larger range is preferred:

$$H 1 * \frac{cos ( α + β )}{cos ( α )} - W * tan ( α ) < H 2 < H 1 * \frac{cos ( α - β )}{cos ( α )} - W * tan ( α ) \qquad Equation 3$$

FIGS. 5a and 5b illustrate perspective underside views of a dual-blade wiper blade 500a, 500b in accordance with other aspects of the present disclosure. While the scraping lip 208 has been generally illustrate and described thus far as a rubber element, the scraping lip 208 can be embodied as another structure, such as a first brush 502 and/or a second brush 504, each having a plurality of bristles arranged in a row. In some examples, a first brush 502 can be provided on just one side of the wiping lip 206 as illustrated in FIG. 5a. In another example, a first brush 502 and a second brush 504 can be provided on each side of the wiping lip 206 as illustrated in FIG. 5b.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A dual-blade wiper blade for a windshield of a vehicle, the dual-blade wiper blade comprising:
a frame structure;
a squeegee coupled to the frame structure;
a wiping lip coupled to the squeegee; and
a scraping lip coupled to the squeegee and positioned in parallel with the wiping lip.

2. The dual-blade wiper blade of claim 1, wherein the wiping lip extends from the squeegee at a first height (H₁) and the scraping lip extends from the squeegee at a second height (H₂) that is different form the first height (H₁).

3. The dual-blade wiper blade of claim 2, wherein the second height (H₂) is less than the first height (H₁).

4. The dual-blade wiper blade of claim 1, wherein the wiping lip is a first rubber element and the scraping lip is a second rubber element.

5. The dual-blade wiper blade of claim 4, wherein the first rubber element is less rigid than the second rubber element.

6. The dual-blade wiper blade of claim 1, wherein the wiping lip is a rubber element and the scraping lip is a brush.

7. The dual-blade wiper blade of claim 1, wherein the wiping lip is a rubber element and the scraping lip is a sponge.

8. The dual-blade wiper blade of claim 1, wherein the wiping lip is a rubber element and the scraping lip is a scrubbing pad.

9. The dual-blade wiper blade of claim 1, wherein the wiping lip comprises a hard coating.

10. The dual-blade wiper blade of claim 2, wherein the first height (H₁) is between 50% and 100% greater than the second height (H₂).

11. The dual-blade wiper blade of claim 2, wherein the first height (H₁) is between 60% and 90% greater than the second height (H₂).

12. The dual-blade wiper blade of claim 1, wherein the scraping lip is removably coupled to the squeegee.

13. A dual-blade wiper blade for a windshield of a vehicle, the dual-blade wiper blade comprising:
a squeegee;
a wiping lip coupled to the squeegee; and
a scraping lip coupled to the squeegee and positioned in parallel with the wiping lip,
wherein the wiping lip extends from the squeegee at a first height (H₁) and the scraping lip extends from the squeegee at a second height (H₂) that is different form the first height (H₁).

14. The dual-blade wiper blade of claim 13, wherein the second height (H₂) is less than the first height (H₁).

15. The dual-blade wiper blade of claim 13, wherein the wiping lip is a first rubber element and the scraping lip is a second rubber element that is more rigid than the second rubber element.

16. The dual-blade wiper blade of claim 13, wherein the wiping lip is a rubber element and the scraping lip is a brush, a sponge, or a scrubbing pad.

17. The dual-blade wiper blade of claim 13, wherein the wiping lip comprises a hard coating.

18. The dual-blade wiper blade of claim 2, wherein the first height (H₁) is between 50% and 100% greater than the second height (H₂).

19. A dual-blade wiper blade for a windshield of a vehicle, the dual-blade wiper blade comprising:
a squeegee;
a wiping lip coupled to the squeegee, wherein the wiping lip is a rubber element; and
a scraping lip coupled to the squeegee and positioned in parallel with the wiping lip,
wherein the wiping lip extends from the squeegee at a first height (H₁) and the scraping lip extends from the squeegee at a second height (H₂) that is different form the first height (H₁), and
wherein the scraping lip comprises a brush, a sponge, or a scrubbing pad.

20. The dual-blade wiper blade of claim 19, wherein the second height (H₂) is less than the first height (H₁).
